(19) United States
(12) Patent Application Publication
(10) Pub. No.: US 2002/0081007 A1
(43) Pub. Date: Jun. 27, 2002

(54) Radiation image signal processing method and apparatus

(75) Inventor: Satoshi Arakawa, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 10/026,433

(22) Filed: Dec. 27, 2001

(30) Foreign Application Priority Data
Dec. 27, 2000 (JP) 397113/2000

(51) Int. Cl. G06K 9/32

(52) U.S. Cl. 382/130; 382/132; 382/295

(57) ABSTRACT

Image position correcting processing is performed on a low energy image signal and/or a high energy image signal, and a pair of corrected original image signals are thereby obtained. First energy subtraction processing is performed on the pair of the corrected original image signals, and second energy subtraction processing is thereafter performed with respect to the low energy image signal and the high energy image signal. The second energy subtraction processing is performed by the utilization of the pair of the corrected original image signals, which have been obtained at the time of the first energy subtraction processing.

### BACKGROUND OF THE INVENTION

1. Field of the Invention

This invention relates to a radiation image signal processing method and apparatus. This invention particularly relates to a radiation image signal processing method and apparatus, wherein an energy subtraction image signal is formed from a subtraction process performed between a plurality of image signals representing radiation images.

2. Description of the Related Art

It has been proposed to use stimulable phosphors in radiation image recording and reproducing systems. Specifically, a radiation image of an object, such as a human body, is recorded on a sheet provided with a layer of the stimulable phosphor (hereinafter referred to as a stimulable phosphor sheet). The stimulable phosphor sheet, on which the radiation image has been stored, is then exposed to stimulating rays, such as a laser beam, which cause the stimulable phosphor sheet to emit light in proportion to the amount of energy stored thereon during its exposure to the radiation. The light emitted by the stimulable phosphor sheet, upon stimulation thereof, is photoelectrically detected, and an image signal is thereby obtained. The image signal is then processed and used for the reproduction of the radiation image of the object as a visible image on a recording material.

Also, techniques for performing energy subtraction processing on radiation images have heretofore been known. With the energy subtraction processing techniques, radiation images of an object, which contains a plurality of structures having different radiation energy absorption characteristics, are formed respectively on, for example, two stimulable phosphor sheets and with radiation carrying image information of the object. The radiation images are then read out from the stimulable phosphor sheets, on which the radiation images have been stored, and a low energy image signal and a high energy image signal representing the radiation images are thereby obtained. Thereafter, a subtraction process is performed between the low energy image signal and the high energy image signal, and an energy subtraction image signal, which represents a specific structure of the object, is obtained from the subtraction process.

The energy subtraction processing techniques described above utilize the characteristics such that a plurality of structures contained in an object, e.g. a bone and a soft tissue contained in a human body, have different radiation absorption characteristics with respect to radiation having different energy distributions. By the utilization of the characteristics described above, two radiation images are formed respectively with high energy radiation and low energy radiation carrying the image information of the object, and two kinds of image signals (i.e., a low energy image signal and a high energy image signal) representing the radiation images of the object are obtained. Thereafter, energy subtraction processing is performed on the two kinds of the image signals. Specifically, a subtraction process is performed between the two kinds of the image signals. In this manner, an energy subtraction image signal (i.e., a bone image signal) representing a bone image, in which only the pattern of the bone acting as the specific structure contained in the object is illustrated, or an energy subtraction image signal (i.e., a soft tissue image signal) representing a soft tissue image, in which only the pattern of the soft tissue acting as the specific structure contained in the object is illustrated, is formed. The energy subtraction processing techniques are described in, for example, U.S. Pat. Nos. 4,855,598, 4,896,037 and 5,485,371.

More specifically, for example, in cases where the energy subtraction processing described above is performed for forming a radiation image of the bronchus at the chest, the patterns of the ribs superposed upon the pattern of the bronchus to be seen are capable of being rendered thin. Therefore, from the energy subtraction processing, an energy subtraction image is capable of being obtained, such that the pattern of the soft tissue, such as the bronchus, which has heretofore been seen as the pattern superposed upon the bone pattern, such as the rib pattern, is easy to see.

Techniques for recording the radiation images, which are to be subjected to the energy subtraction processing, on the stimulable phosphor sheets may be classified into a one-shot energy subtraction processing technique described in, for example, U.S. Pat. Nos. 4,855,598 and 5,485,371, and a two-shot energy subtraction processing technique described in, for example, U.S. Pat. No. 4,896,037. With the one-shot energy subtraction processing technique, two stimulable phosphor sheets are superposed one upon the other with a filter, which absorbs low energy components of radiation, intervening therebetween, and radiation carrying the image information of the object is irradiated to the two stimulable phosphor sheets. In this manner, a radiation image formed with high energy radiation and a radiation image formed with low energy radiation are simultaneously stored respectively on the two stimulable phosphor sheets with one radiation image recording operation. With the two-shot energy subtraction processing technique, the radiation image formed with the high energy radiation and the radiation image formed with the low energy radiation are stored respectively on the two stimulable phosphor sheets with two radiation image recording operations utilizing two kinds of radiation having different energy distributions.

The radiation image having been stored on each of the stimulable phosphor sheets is read out from each stimulable phosphor sheet with a radiation image read-out apparatus. The image signal having been detected from the stimulable phosphor sheet, on which the radiation image formed with the low energy radiation has been stored, is outputted as the low energy image signal. Also, the image signal having been detected from the stimulable phosphor sheet, on which the radiation image formed with the high energy radiation has been stored, is outputted as the high energy image signal.

The energy subtraction image signal is formed from the low energy image signal and the high energy image signal. However, the positions of the radiation images of the object, which radiation images are represented by the low energy image signal and the high energy image signal, do not coincide with each other. Therefore, if the energy subtraction processing is performed directly on the low energy image signal and the high energy image signal, an energy subtraction image signal representing an energy subtraction image, in which the bone pattern or the soft tissue pattern has been erased accurately, cannot be obtained.

Specifically, various errors in position occur before the low energy image signal and the high energy image signal are detected from the stimulable phosphor sheets. For example, in the cases of the one-shot energy subtraction processing technique, the radiation, which has been irradiated radially from an X-ray tube toward the object, impinges upon the two stimulable phosphor sheets superposed one upon the other. Therefore, the images of the object, which images have different sizes, are stored on the two stimulable phosphor sheets. Also, in the cases of the two-shot energy subtraction processing technique, it may occur that a shift occurs between the images of the object stored on the two stimulable phosphor sheets due to an error in position adjustment occurring when the two stimulable phosphor sheets are conveyed one after the other to a position for radiation image recording. Further, when the image signals are readout from the two stimulable phosphor sheets, on which the radiation images have been stored, a shift may occur between the images due to a conveyance error, or the like.

Therefore, as processing preceding to the energy subtraction processing, position correcting processing has heretofore been performed on the low energy image signal and the high energy image signal, such that the positions of the images of the object, which images are represented by the low energy image signal and the high energy image signal having been read out from the two stimulable phosphor sheets, coincide with each other. It often occurs that the energy subtraction processing is performed two or more times on the same pair of the original image signals (i.e., the low energy image signal and the high energy image signal). In such cases, heretofore, the position correcting processing described above has been performed before each of the two or more times of the energy subtraction processings is conducted.

The two or more times of the energy subtraction processings may be performed with an identical apparatus. It may also occur that the low energy image signal and the high energy image signal are transferred to, for example, a work station or a filing apparatus, and the energy subtraction processing is again performed with an apparatus having the energy subtraction processing functions, which apparatus is located at the destination of the signal transfer.

Classification of at least two kinds of radiation into the low energy radiation and the high energy radiation is made by dividing the energy components, which are contained in each kind of the radiation, into low energy components and high energy components with an identical threshold value, calculating the ratio between the low energy components and the high energy components in each kind of the radiation, and comparing the ratios, which have been calculated with respect to the at least two kinds of the radiation, with each other. Specifically, of the at least two kinds of the radiation, the radiation, in which the ratio of the high energy components to the low energy components is high, is taken as the high energy radiation. Also, the radiation, in which the ratio of the high energy components to the low energy components is low, is taken as the low energy radiation. The image having been formed from the low energy image signal is referred to as the low energy image, and the image having been formed from the high energy image signal is referred to as the high energy image.

However, the position correcting processing, which is executed as the processing preceding to the first energy subtraction processing performed on the pair of the original image signals, and the position correcting processing, which is executed as the processing preceding to the energy subtraction re-processing performed on the same pair of the original image signals, are the identical position correcting processing. Therefore, in cases where the position correcting processing is performed before the energy subtraction re-processing, the problems occur in that the time required for the formation of the energy subtraction image signal cannot be kept short.

### SUMMARY OF THE INVENTION

The primary object of the present invention is to provide a radiation image signal processing method, wherein processing time is capable of being kept short in cases where, after energy subtraction processing has been performed, the energy subtraction processing is again performed.

Another object of the present invention is to provide an apparatus for carrying out the radiation image signal processing method.

The present invention provides a radiation image signal processing method, comprising the steps of:

i) performing image position correcting processing for correcting a low energy image signal and/or a high energy image signal, such that a position of an image, which is represented by the low energy image signal, and a position of an image, which is represented by the high energy image signal, coincide with each other, a pair of corrected original image signals being thereby obtained,

ii) performing first energy subtraction processing on the pair of the corrected original image signals, and

iii) performing second energy subtraction processing with respect to the low energy image signal and the high energy image signal,

wherein the second energy subtraction processing is performed by the utilization of the pair of the corrected original image signals, which have been obtained at the time of the first energy subtraction processing.

The radiation image signal processing method in accordance with the present invention may be modified such that the pair of the corrected original image signals, which have been obtained at the time of the first energy subtraction processing, are stored, and

the second energy subtraction processing is performed by the utilization of the pair of the corrected original image signals, which have thus been stored.

Alternatively, the radiation image signal processing method in accordance with the present invention may be modified such that the pair of the corrected original image signals, which have been obtained at the time of the first energy subtraction processing, are transferred to a certain destination, and

the second energy subtraction processing is performed at the transfer destination by the utilization of the pair of the corrected original image signals, which have thus been transferred.

Also, in the radiation image signal processing method in accordance with the present invention, the image position correcting processing may be performed on only the high energy image signal.

The present invention also provides a radiation image signal processing apparatus wherein:

i) image position correcting processing is performed for correcting a low energy image signal and/or a high energy image signal, such that a position of an image, which is represented by the low energy image signal, and a position of an image, which is represented by the high energy image signal, coincide with each other, a pair of corrected original image signals being thereby obtained,

ii) first energy subtraction processing is performed on the pair of the corrected original image signals, and

iii) second energy subtraction processing is performed with respect to the low energy image signal and the high energy image signal,

the second energy subtraction processing being performed by the utilization of the pair of the corrected original image signals, which have been obtained at the time of the first energy subtraction processing.

The radiation image signal processing apparatus in accordance with the present invention may be modified such that the apparatus comprises:

a) common energy subtraction processing means for performing the first energy subtraction processing and the second energy subtraction processing,

b) storage means for storing the pair of the corrected original image signals, which have been obtained at the time of the first energy subtraction processing,

c) instruction means for outputting an instruction for performing the second energy subtraction processing, and

d) control means for controlling the common energy subtraction processing means in accordance with the instruction, which has been outputted from the instruction means, such that the common energy subtraction processing means performs the second energy subtraction processing by the utilization of the pair of the corrected original image signals, which have been stored in the storage means.

Alternatively, the radiation image signal processing apparatus in accordance with the present invention may be modified such that the apparatus comprises:

a) first energy subtraction processing means for performing the first energy subtraction processing,

b) second energy subtraction processing means for performing the second energy subtraction processing,

c) storage means for storing the pair of the corrected original image signals, which have been obtained at the time of the first energy subtraction processing,

d) instruction means for outputting an instruction for performing the second energy subtraction processing, and

e) control means for controlling the second energy subtraction processing means in accordance with the instruction, which has been outputted from the instruction means, such that the second energy subtraction processing means performs the second energy subtraction processing by the utilization of the pair of the corrected original image signals, which have been stored in the storage means.

As another alternative, the radiation image signal processing apparatus in accordance with the present invention may be modified such that the apparatus comprises:

a) first energy subtraction processing means for performing the first energy subtraction processing,

b) second energy subtraction processing means for performing the second energy subtraction processing,

c) instruction means for outputting an instruction for performing the second energy subtraction processing, and

d) control means for transferring the pair of the corrected original image signals, which have been obtained at the time of the first energy subtraction processing, to the second energy subtraction processing means, and controlling the second energy subtraction processing means in accordance with the instruction, which has been outputted from the instruction means, such that the second energy subtraction processing means performs the second energy subtraction processing by the utilization of the pair of the corrected original image signals, which have thus been transferred.

Also, in the radiation image signal processing apparatus in accordance with the present invention, the image position correcting processing may be performed on only the high energy image signal.

In the radiation image signal processing method and apparatus in accordance with the present invention, the image position correcting processing is performed for correcting the low energy image signal and/or the high energy image signal, and the pair of the corrected original image signals are obtained from the image position correcting processing. Specifically, the low energy image signal may not be altered, and only the high energy image signal may be corrected. Alternatively, the high energy image signal may not be altered, and only the low energy image signal may be corrected. As another alternative, both the low energy image signal and the high energy image signal may be corrected. In this manner, the image position correcting processing is performed such that the position of the image, which is represented by the low energy image signal, and the position of the image, which is represented by the high energy image signal, coincide with each other, and the pair of the original image signals are obtained from the image position correcting processing.

The storage means may be a storage medium, such as a hard disk, an optical disk, or a magnetic tape. Alternatively, the storage means may be a circuit, or the like, for temporarily storing the image signals in a signal processing circuit of the radiation image signal processing apparatus.

With the radiation image signal processing method and apparatus in accordance with the present invention, the first energy subtraction processing is performed on the pair of the corrected original image signals, and there after the second energy subtraction processing is performed with respect to the low energy image signal and the high energy image signal. The second energy subtraction processing is performed by the utilization of the pair of the corrected original image signals, which have been obtained at the time of the first energy subtraction processing. (The pair of the corrected original image signals, which are subjected to the second energy subtraction processing, may be the corrected original image signals having been stored or transferred.) Therefore, the position correcting processing, which has heretofore been performed as the processing preceding to the second energy subtraction processing, i.e. the energy subtraction re-processing, is capable of being omitted. Accordingly, the time required for the energy subtraction image signal to be formed with the energy subtraction re-processing is capable of being kept short.

With the radiation image signal processing method and apparatus in accordance with the present invention, wherein the image position correcting processing is performed on only the high energy image signal, no correction is made on the low energy image signal, and the image quality of the low energy image formed from the low energy image signal does not become bad. Therefore, when necessary, the low energy image is capable of being utilized as the image for seeing.

### BRIEF DESCRIPTION OF THE DRAWINGS

FIG. 1 is a block diagram showing a first embodiment of the radiation image signal processing apparatus in accordance with the present invention, and

FIG. 2 is a block diagram showing a second embodiment of the radiation image signal processing apparatus in accordance with the present invention.

### DESCRIPTION OF THE PREFERRED EMBODIMENTS

The present invention will hereinbelow be described in further detail with reference to the accompanying drawings.

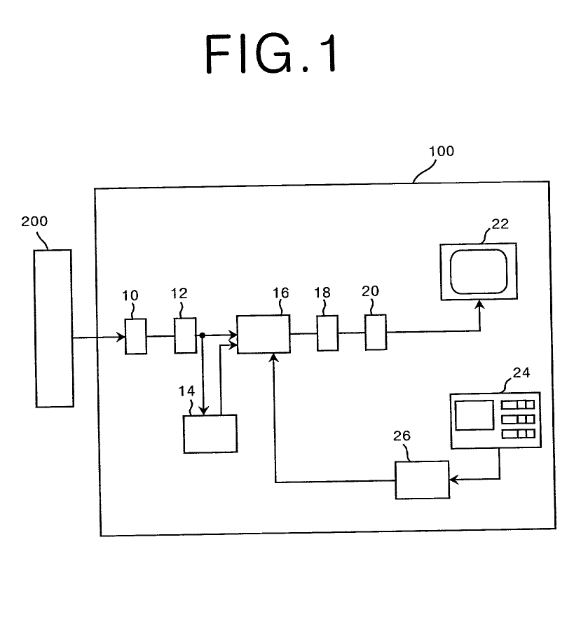

FIG. 1 is a block diagram showing a first embodiment of the radiation image signal processing apparatus for carrying out the radiation image signal processing method in accordance with the present invention. The first embodiment of the radiation image signal processing apparatus in accordance with the present invention is provided with common energy subtraction processing means for performing first energy subtraction processing and second energy subtraction processing.

With reference to FIG. 1, a radiation image signal processing apparatus 100, which acts as the first embodiment of the radiation image signal processing apparatus in accordance with the present invention, comprises a buffer memory 10 for receiving and temporarily storing a low energy image signal and a high energy image signal, which have been obtained from a radiation image recording and read-out apparatus 200 for performing radiation image recording and read-out operations. The radiation image signal processing apparatus 100 also comprises an image position correcting means 12 for receiving the low energy image signal and the high energy image signal from the buffer memory 10 and performing image position correcting processing on only the high energy image signal, such that the position of an image, which is represented by the low energy image signal, and the position of an image, which is represented by the high energy image signal, coincide with each other. From the image position correcting processing, a pair of corrected original image signals are obtained. The radiation image signal processing apparatus 100 further comprises ES processing means 16, which acts as the common energy subtraction processing means. The ES processing means 16 performs the first energy subtraction processing and the second energy subtraction processing on the pair of the corrected original image signals, which are received from the image position correcting means 12, in order to form energy subtraction image signals. The radiation image signal processing apparatus 100 still further comprises an image memory 18 for temporarily storing each of the energy subtraction image signals received from the ES processing means 16. The radiation image signal processing apparatus 100 also comprises a video signal processing circuit 20 for transforming the energy subtraction image signal, which is received from the image memory 18, into a display signal, from which a visible image is capable of being reproduced. The radiation image signal processing apparatus 100 further comprises an image displaying section 22 for reproducing the visible image from the display signal, which is received from the video signal processing circuit 20, and displaying the visible image. The radiation image signal processing apparatus 100 still further comprises storage means 14 for storing the pair of the corrected original image signals, which are received from the image position correcting means 12.

The radiation image signal processing apparatus 100 also comprises an operation panel 24, which acts as instruction means for giving an instruction for again forming an energy subtraction image signal from the low energy image signal and the high energy image signal. The radiation image signal processing apparatus 100 further comprises control means 26 for controlling the ES processing means 16 in accordance with the instruction, which has been given from the operation panel 24, such that the ES processing means 16 performs the energy subtraction re-processing by the utilization of the pair of the corrected original image signals, which have been stored in the storage means 14.

How the aforesaid embodiment of the radiation image signal processing apparatus in accordance with the present invention operates will be described hereinbelow.

The low energy image signal and the high energy image signal, which have been obtained from the radiation image recording and read-out apparatus 200, are fed via the buffer memory 10 into the image position correcting means 12. In the image position correcting means 12, the image position correcting processing is performed.

In the image position correcting means 12, by way of example, the image position correcting processing may be performed in the manner described below. Specifically, as described in, for example, Japanese Unexamined Patent Publication Nos. 3(1991)-109679 and 3(1991)-285476, when the radiation image recording operation is performed in the radiation image recording and read-out apparatus 200, patterns of a plurality of markers (i.e., the patterns whose positions are capable of being discriminated, such as circular patterns or cross patterns), which are fixed with respect to the position of the object, are recorded on the two stimulable phosphor sheets together with the object images. When the object images are read out from the two stimulable phosphor sheets, the marker patterns are read out together with the object images. In this manner, the low energy image signal and the high energy image signal, which represent the object images and the marker patterns, are obtained.

Thereafter, the image position correcting processing, such as translation, rotating processing, and image size enlargement or reduction processing, is performed on the image, which is represented by the high energy image signal, such that the positions of the plurality of the marker patterns represented by the high energy image signal coincide with the positions of the plurality of the marker patterns represented by the low energy image signal. In this manner, the pair of the corrected original image signals are obtained from the image position correcting processing, such that the positions of the marker patterns represented by the low energy image signal and the positions of the marker patterns represented by the high energy image signal coincide with each other.

In order for the positions of the marker patterns to be caused to coincide with each other, template matching, or the like, may be performed between the marker patterns, and a shift quantity between the marker patterns may thereby be calculated. Alternatively, the positions of the marker patterns themselves may be detected with edge detection processing, or the like.

Such that clear marker patterns may be obtained, the markers should preferably be constituted of a material having a high radiation absorptivity, such as lead or tungsten. Also, the markers should preferably be located at the positions such that the marker patterns do not overlap upon the object images.

In the manner described above, the pair of the corrected original image signals may be obtained by the utilization of the markers. Alternatively, as described in, for example, Japanese Unexamined Patent Publication No. 7 (1995)-244722, instead of the markers being used, the image signals may be corrected such that correspondence points in the object images coincide with each other.

The pair of the corrected original image signals, which have been obtained from the image position correcting means 12, are fed into and stored in the storage means 14. The pair of the corrected original image signals are also fed into the ES processing means 16. The ES processing means 16 forms the energy subtraction image signal (i.e., a soft tissue image signal or a bone image signal) by utilizing the pair of the corrected original image signals having been received from the image position correcting means 12. The energy subtraction image signal having been obtained from the ES processing means 16 is fed into the image memory 18 and then into the video signal processing circuit 20. The display signal, which is obtained from the video signal processing circuit 20 in accordance with the energy subtraction image signal, is fed into the image displaying section 22 and utilized for reproducing and displaying the visible image.

In cases where an instruction for again forming an energy subtraction image signal in accordance with the low energy image signal and the high energy image signal is given from the operation panel 24, the ES processing means 16 receives the pair of the corrected original image signals, which have already been subjected to the image position correcting processing, from the storage means 14. Also, the ES processing means 16 performs the energy subtraction re-processing by utilizing the pair of the corrected original image signals and forms the energy subtraction image signal. In the same manner as that for the energy subtraction image signal described above, the energy subtraction image signal having thus been formed with the energy subtraction re-processing is fed into the image memory 18 and then into the video signal processing circuit 20. The display signal, which is obtained from the video signal processing circuit 20 in accordance with the energy subtraction image signal having been formed with the energy subtraction re-processing, is fed into the image displaying section 22 and utilized for reproducing and displaying a visible image.

In cases where the energy subtraction re-processing is to be performed, the control means 26 receives the instruction from the operation panel 24 and controls such that the pair of the corrected original image signals having been stored in the storage means 14 are utilized for the energy subtraction re-processing.

In the manner described above, the position correcting processing, which has heretofore been performed as the processing preceding to the energy subtraction re-processing, is capable of being omitted. Accordingly, the time required for the energy subtraction image signal to be formed with the energy subtraction re-processing is capable of being kept short.

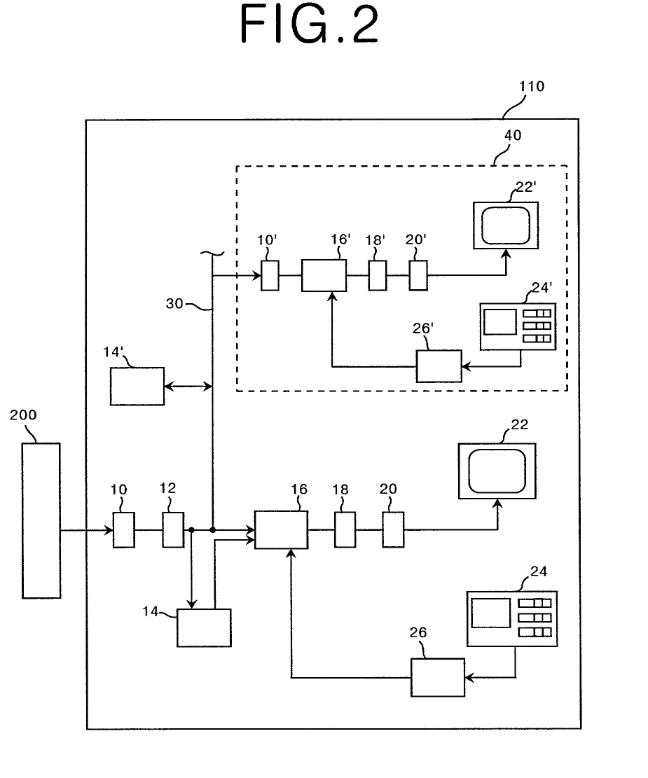

FIG. 2 is a block diagram showing a second embodiment of the radiation image signal processing apparatus for carrying <out the radiation image signal processing method in accordance with the present invention. The second embodiment of the radiation image signal processing apparatus in accordance with the present invention is provided with first energy subtraction processing means for forming an energy subtraction image signal by utilizing the low energy image signal and the high energy image signal, which have been obtained from the radiation image recording and read-out apparatus. The second embodiment of the radiation image signal processing apparatus in accordance with the present invention is also provided with second energy subtraction processing means for forming an energy subtraction image signal by utilizing the pair of the corrected original image signals, which have been stored in a filing device. In FIG. 2, similar elements are numbered with the same reference numerals with respect to FIG. 1.

With reference to FIG. 2, a radiation image signal processing apparatus 110, which acts as the second embodiment of the radiation image signal processing apparatus in accordance with the present invention, comprises a signal transfer cable 30 for transferring the pair of the corrected original image signals, which have been obtained from the image position correcting means 12, into a plurality of other devices. The radiation image signal processing apparatus 110 also comprises a filing device 14′ for storing the pair of the corrected original image signals, which have been transferred through the signal transfer cable 30. The radiation image signal processing apparatus 110 further comprises a work station 40 for forming the energy subtraction image signal by utilizing the pair of the corrected original image signals, which have been received through the signal transfer cable 30.

The work station 40 comprises a buffer memory 10′ for temporarily storing the pair of the corrected original image signals, which have been received through the signal transfer cable 30. The work station 40 also comprises second energy subtraction processing means 16′ for forming the energy subtraction image signal by utilizing the pair of the corrected original image signals, which have been received from the buffer memory 10′. The work station 40 further comprises an image memory 18′ for temporarily storing the energy subtraction image signal received from the second energy subtraction processing means 16′. The work station 40 still further comprises a video signal processing circuit 20′ for transforming the energy subtraction image signal, which is received from the image memory 18′, into a display signal, from which a visible image is capable of being reproduced. The work station 40 also comprises an image displaying section 22′ for reproducing the visible image from the display signal, which is received from the video signal processing circuit 20′, and displaying the visible image.

The work station 40 further comprises an operation panel 24′, which acts as instruction means for giving an instruction for forming the energy subtraction image signal. The workstation 40 still further comprises control means 26′ for controlling the second energy subtraction processing means 16′ in accordance with the instruction, which has been given from the operation panel 24′, such that the second energy subtraction processing means 16′ performs the energy subtraction re-processing by the utilization of the pair of the corrected original image signals, which have been stored in the storage means 14′. The other features of the second embodiment are the same as those of the first embodiment described above. The first energy subtraction processing on the pair of the corrected original image signals, which have been obtained from the image position correcting means 12, is performed by the ES processing means 16. In the second embodiment, the ES processing means 16 acts as the first energy subtraction processing means.

How the second embodiment of the radiation image signal processing apparatus in accordance with the present invention operates will be described hereinbelow.

The low energy image signal and the high energy image signal, which have been obtained from the radiation image recording and read-out apparatus 200, are fed via the buffer memory 10 into the image position correcting means 12. In the image position correcting means 12, the image position correcting processing is performed.

The pair of the corrected original image signals, which have been obtained from the image position correcting means 12, are fed into and stored in the storage means 14. The pair of the corrected original image signals are also transferred through the signal transfer cable 30 and stored in the filing device 14′.

Further, the pair of the corrected original image signals are fed into the ES processing means 16 (hereinbelow referred to as the first ES processing means 16). The first ES processing means 16 forms the energy subtraction image signal (i.e., a soft tissue image signal or a bone image signal) by utilizing the pair of the corrected original image signals having been received from the image position correcting means 12. The energy subtraction image signal having been obtained from the first ES processing means 16 is fed into the image memory 18 and then into the video signal processing circuit 20. The display signal, which is obtained from the video signal processing circuit 20 in accordance with the energy subtraction image signal, is fed into the image displaying section 22 and utilized for reproducing and displaying the visible image.

In cases where an instruction for performing the energy subtraction re-processing with respect to the low energy image signal and the high energy image signal is given from the operation panel 24′ located in the work station 40, the second energy subtraction processing means 16′ receives the pair of the corrected original image signals, which have already been subjected to the image position correcting processing, from the filing device 14′. Also, the second energy subtraction processing means 16′ performs the energy subtraction re-processing by utilizing the pair of the corrected original image signals and forms the energy subtraction image signal. The energy subtraction image signal having thus been formed with the energy subtraction re-processing is fed into the image memory 18′ and then into the video signal processing circuit 20′. The display signal, which is obtained from the video signal processing circuit 20′ in accordance with the energy subtraction image signal having been formed with the energy subtraction re-processing, is fed into the image displaying section 22′ and utilized for reproducing and displaying a visible image.

In cases where the energy subtraction re-processing is to be performed, the control means 26′ receives the instruction from the operation panel 24′ and controls such that the pair of the corrected original image signals having been stored in the filing device 14′ are utilized for the energy subtraction re-processing.

The energy subtraction re-processing, which is performed by the second energy subtraction processing means 16′, may be conducted by utilizing the pair of the corrected original image signals, which have directly been transferred from the storage means 14 or the image position correcting means 12 into the work station 40.

In the first and second embodiments described above, the image position correcting processing in the image position correcting means 12 is performed on only the high energy image signal. Alternatively, the image position correcting processing maybe performed on only the low energy image signal. As another alternative, the image position correcting processing may be performed on both the low energy image signal and the high energy image signal.

In cases where the energy subtraction re-processing is executed, processing conditions, such as parameters, may be altered, and the energy subtraction re-processing on the same pair of the corrected original image signals may be conducted multiple times. In this manner, a soft image or a bone image more suitable for the seeing may be selected.

In the manner described above, in cases where the energy subtraction re-processing is performed by the different ES processing means, the position correcting processing, which has heretofore been performed as the processing preceding to the energy subtraction re-processing, is capable of being omitted. Accordingly, the time required for the energy subtraction image signal to be formed with the energy subtraction re-processing is capable of being kept short.

The storage means 14 may be constituted of a hard disk, or the like. Also, the filing device 14′ may utilize a storage medium, such as an optical disk or magnetic tape.

The signal transfer cable 30 for transferring the pair of the corrected original image signals may be constituted of an electric wire, an optical fiber, or the like. Alternatively, the signal transfer cable 30 maybe replaced by any signal transfer means, such as radio communication means. Also, no limitation is imposed upon the signal transfer system, the signal transfer form, and the like.

What is claimed is:

1. A radiation image signal processing method, comprising the steps of:
i) performing image position correcting processing for correcting a low energy image signal and/or a high energy image signal, such that a position of an image, which is represented by the low energy image signal, and a position of an image, which is represented by the high energy image signal, coincide with each other, a pair of corrected original image signals being thereby obtained,
ii) performing first energy subtraction processing on the pair of the corrected original image signals, and
iii) performing second energy subtraction processing with respect to the low energy image signal and the high energy image signal,
wherein the second energy subtraction processing is performed by the utilization of the pair of the corrected original image signals, which have been obtained at the time of the first energy subtraction processing.

2. A method as defined in claim 1 wherein the pair of the corrected original image signals, which have been obtained at the time of the first energy subtraction processing, are stored, and
the second energy subtraction processing is performed by the utilization of the pair of the corrected original image signals, which have thus been stored.

3. A method as defined in claim 1 wherein the pair of the corrected original image signals, which have been obtained at the time of the first energy subtraction processing, are transferred to a certain destination, and
the second energy subtraction processing is performed at the transfer destination by the utilization of the pair of the corrected original image signals, which have thus been transferred.

4. A method as defined in claim 1, 2, or 3 wherein the image position correcting processing is performed on only the high energy image signal.

5. A radiation image signal processing apparatus wherein:
i) image position correcting processing is performed for correcting a low energy image signal and/or a high energy image signal, such that a position of an image, which is represented by the low energy image signal, and a position of an image, which is represented by the high energy image signal, coincide with each other, a pair of corrected original image signals being thereby obtained,
ii) first energy subtraction processing is performed on the pair of the corrected original image signals, and
iii) second energy subtraction processing is performed with respect to the low energy image signal and the high energy image signal,
the second energy subtraction processing being performed by the utilization of the pair of the corrected original image signals, which have been obtained at the time of the first energy subtraction processing.

6. An apparatus as defined in claim 5 wherein the apparatus comprises:
a) common energy subtraction processing means for performing the first energy subtraction processing and the second energy subtraction processing,
b) storage means for storing the pair of the corrected original image signals, which have been obtained at the time of the first energy subtraction processing,
c) instruction means for outputting an instruction for performing the second energy subtraction processing, and
d) control means for controlling the common energy subtraction processing means in accordance with the instruction, which has been outputted from the instruction means, such that the common energy subtraction processing means performs the second energy subtraction processing by the utilization of the pair of the corrected original image signals, which have been stored in the storage means.

7. An apparatus as defined in claim 5 wherein the apparatus comprises:
a) first energy subtraction processing means for performing the first energy subtraction processing,
b) second energy subtraction processing means for performing the second energy subtraction processing,
c) storage means for storing the pair of the corrected original image signals, which have been obtained at the time of the first energy subtraction processing,
d) instruction means for outputting an instruction for performing the second energy subtraction processing, and
e) control means for controlling the second energy subtraction processing means in accordance with the instruction, which has been outputted from the instruction means, such that the second energy subtraction processing means performs the second energy subtraction processing by the utilization of the pair of the corrected original image signals, which have been stored in the storage means.

8. An apparatus as defined in claim 5 wherein the apparatus comprises:
a) first energy subtraction processing means for performing the first energy subtraction processing,
b) second energy subtraction processing means for performing the second energy subtraction processing,
c) instruction means for outputting an instruction for performing the second energy subtraction processing, and
d) control means for transferring the pair of the corrected original image signals, which have been obtained at the time of the first energy subtraction processing, to the second energy subtraction processing means, and controlling the second energy subtraction processing means in accordance with the instruction, which has been outputted from the instruction means, such that the second energy subtraction processing means performs the second energy subtraction processing by the utilization of the pair of the corrected original image signals, which have thus been transferred.

9. An apparatus as defined in claim 5, 6, 7, or 8 wherein the image position correcting processing is performed on only the high energy image signal.
